(19) United States
(12) Patent Application Publication
(10) Pub. No.: US 2007/0081787 A1
(43) Pub. Date: Apr. 12, 2007

(54) Display apparatus and control method thereof

(75) Inventors: Joo-sun Hong, Suwon-si (KR); Baik-hee Han, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/541,556

(22) Filed: Oct. 3, 2006

(30) Foreign Application Priority Data
Oct. 10, 2005 (KR) 2005-0095142

(51) Int. Cl. H04N 5/91

(52) U.S. Cl. 386/83

(57) ABSTRACT

Provided is a display apparatus including a broadcasting receiver for receiving a broadcast signal, a signal processing unit for processing the received broadcast signal, a display unit for displaying the processed broadcast signal thereon, a connection unit to which at least one external storage medium is connected, and an internal storage medium, the display apparatus including a user selector; a priority storage unit for storing a storage priority of the external storage medium and the internal storage medium for the reserve-recording of a broadcasting program; a reservation information storage unit for storing reservation information related to the broadcasting program to be reserve-recorded; and a controller for controlling the reservation information relating to a selected broadcasting program to be stored in the reservation information storage unit if the broadcasting program to be reserve-recorded is selected through the user selector, and for receiving the broadcasting program to be reserve-recorded from the broadcasting receiver based on the reservation information in order to reserve-record the received broadcasting program on one of the external storage medium and the internal storage medium according to the storage priority.

### CROSS-REFERENCE TO RELATED APPLICATIONS

This application claims the benefit under 35 U.S.C. §119(a) of Korean Patent Application No. 2005-0095142, filed on Oct. 10, 2005, in the Korean Intellectual Property Office, the entire disclosure of which is hereby incorporated by reference.

### BACKGROUND OF THE INVENTION

1. Field of the Invention

The present invention relates to a display apparatus and a control method thereof. More particularly, the present invention relates to a display apparatus for reserve-recording broadcasting programs and a control method thereof.

2. Description of the Related Art

In TVs having a broadcasting reception function, broadcasting programs can be recorded on various storage media such as a built-in Hard Disc Drive (HDD), an externally connected HDD, and a Video Cassette Recorder (VCR).

Generally, in order to reserve-record broadcasting programs in conventional TVs, a user sets a recording start time and a recording end time of each broadcasting program in advance, and designates storage media on a menu so that the broadcasting programs can be recorded on the designated storage media.

Moreover, broadcasting programs can be reserve-recorded by using Electronic Program Guide (EPG) information. In this case, it is not clear whether the broadcasting programs indicated on the Electronic Program Guide (EPG) are digital broadcasting programs or analog broadcasting programs. As a result, a user has to select storage media on a menu one by one in order to record the broadcasting programs on the selected storage media.

Accordingly, there is a need for an improved display apparatus and a control method thereof, in which a priority of storage media for reserve-recording is set in advance, and broadcasting programs to be reserve-recorded are selected and automatically recorded on corresponding media.

### SUMMARY OF THE INVENTION

Exemplary embodiments of the present invention address at least the above problems and/or disadvantages and provide at least the advantages described below. Accordingly, an aspect of the present invention is to provide a display apparatus and a control method thereof, in which a priority of media for reserve-recording is set in advance, and broadcasting programs to be reserve-recorded are selected and automatically recorded on corresponding media.

The foregoing and/or other aspects of exemplary embodiments of the present invention are achieved by providing a display apparatus including a broadcasting receiver for receiving a broadcast signal, a signal processing unit for processing the received broadcast signal, a display unit for displaying the processed broadcast signal thereon, a connection unit to which at least one external storage medium is connected, and an internal storage medium, the display apparatus comprising a user selector; a priority storage unit for storing a storage priority of the external storage medium and the internal storage medium for the reserve-recording of a broadcasting program; a reservation information storage unit for storing reservation information related to the broadcasting program to be reserve-recorded; and a controller for controlling the reservation information relating to a selected broadcasting program to be stored in the reservation information storage unit if the broadcasting program to be reserve-recorded is selected through the user selector, and for receiving the broadcasting program to be reserve-recorded from the broadcasting receiver based on the reservation information in order to reserve-record the received broadcasting program on one of the external storage medium and the internal storage medium according to the storage priority.

According to the exemplary embodiment of the present invention, the display apparatus further comprises an Electronic Program Guide (EPG) storage unit for storing guide information relating to broadcasting programs received through the broadcasting receiver; and a User Interface (UI) generator for generating a guide information table relating to the broadcasting program, wherein the controller controls the guide information relating to the broadcasting program to be reserve-recorded, to be stored in the reservation information storage unit, if a predetermined program is selected as the broadcasting program to be reserve-recorded from the guide information table via the user selector.

According to an exemplary embodiment of the present invention, the connection unit comprises access ports connected to at least one of a Video Cassette Recorder (VCR) and a Hard Disc Drive (HDD), and the internal storage medium comprises a HDD.

According to an exemplary embodiment of the present invention, the signal processing unit comprises an analog decoder for converting analog broadcasting signals into digital broadcasting signals, and a digital decoder for decoding the digital broadcasting signals, and the controller comprises a Central Processing Unit (CPU), microcomputer, or processor.

According to an exemplary embodiment of the present invention, the UI generator produces a priority setting menu for setting the storage priority of the external storage medium and the internal storage medium for the reserve-recording of the broadcasting program, and wherein the controller controls the UI generator to produce the priority setting menu for display on the display unit, if a priority setting function is selected from the user selector, and the controller controls the priority storage unit to store information relating to a selected storage priority if the storage priority is selected through the user selector.

The foregoing and/or other aspects of exemplary embodiments of the present invention are also achieved by providing a control method of controlling a display apparatus including a broadcasting receiver for receiving a broadcast signal, a signal processing unit for processing the received broadcast signal, a display unit for displaying the processed broadcast signal thereon, a connection unit connected to at least one external storage medium, an internal storage medium and a user selector, the control method comprising the steps of storing a storage priority of the external storage medium and the internal storage medium for the to reserve-recording of a broadcasting program selected via the user selector; storing reservation information relating to a selected broadcasting programs, if the broadcasting program to be reserve-recorded is selected via the user selector; and receiving the broadcasting program to be reserve-recorded from the broadcasting receiver based on the reservation information, and reserve-recording the received broadcasting program on one of the external storage medium and the internal storage medium according to the storage priority.

According to an exemplary embodiment of the present invention, the control method further comprises storing broadcasting program guide information received through the broadcasting receiver; and generating and displaying a guide information table relating to broadcasting programs, if a guide information display function is selected via the user selector, wherein the storing of the reservation information comprises storing the guide information relating to the reserved broadcasting program to be reserve-recorded, if a program is selected as the broadcasting program to be reserve-recorded from the guide information table via the user selector.

According to an exemplary embodiment of the present invention, the connection unit comprises access ports connected to which at least one of a Video Cassette Recorder (VCR) and a Hard Disc Drive (HDD), and the internal storage medium comprises an HDD.

According to an exemplary embodiment of the present invention, the control method further comprises displaying a priority setting menu on the display unit, if a priority setting function is selected from the user selector.

The foregoing and/or other aspects of exemplary embodiments of the present invention are also achieved by providing a display apparatus including a broadcasting receiver for receiving a broadcast signal, a signal processing unit for processing the received broadcast signal, a display unit for displaying the processed broadcast signal, a connection unit connected to at least one external storage medium, and an internal storage medium, the display apparatus comprising a user selector; a priority storage unit for storing a storage priority of the external storage medium and the internal storage medium for the reserve-recording of a broadcasting program; a User Interface (UI) generator for producing a UI menu for setting the storage priority; a controller for controlling the UI generator to produce the UI menu to be displayed on the display unit if the storage priority is selected through the user selector, and for controlling the priority storage unit to store information relating to the storage priority selected via the user selector.

According to exemplary embodiments of the present invention, the display apparatus further comprises a reservation information storage unit for storing reservation information relating to the broadcasting program to be reserve-recorded, wherein the controller controls the reservation information storage unit to store the reservation information relating to a selected broadcasting program if the broadcasting program to be reserve-recorded is selected via the user selector, and the controller receives the reserved broadcasting program to be reserve-recorded based on the reservation information in order to reserve-recorded on one of the external storage medium and the internal storage medium according to the storage priority.

According to an exemplary embodiment of the present invention, the display apparatus further comprises an Electronic Program Guide (EPG) storage unit for storing guide information relating to broadcasting programs received through the broadcasting receiver; and the User Interface (UI) generator for generating a guide information table relating to the broadcasting programs, wherein the controller controls the guide information relating to the broadcasting program to be reserve-recorded to be stored in the reservation information storage unit, if a broadcasting program is selected to be reserve-recorded from the guide information via the user selector.

According to an exemplary embodiment of the present invention, the connection unit comprises access ports connected to at least one of a Video Cassette Recorder (VCR) and a Hard Disc Drive (HDD), and the internal storage medium is a HDD.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 shows a block diagram for a TV according to an exemplary embodiment of the present invention;

FIG. 2 is a flowchart illustrating a priority setting method of setting a priority of a storage medium according to an exemplary embodiment of the present invention;

FIG. 3 shows an electronic program guide (EPG) information display screen according to an exemplary embodiment of the present invention; and

FIG. 4 shows a flowchart for illustrating a reservation recording method of reserve-recording broadcasting programs according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

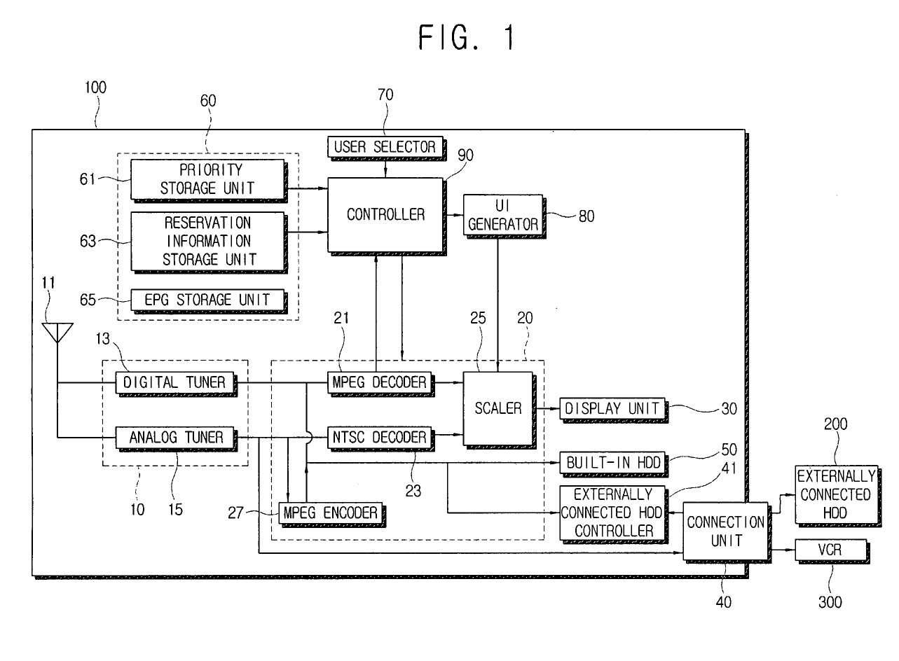

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Reference will now be made in detail to exemplary embodiments of the present invention, examples of which are illustrated in the accompanying drawings. The exemplary embodiments are described below in order to explain the present invention by referring to the FIGS. 1 to 4.

FIG. 1 shows a control block diagram of a TV 100 according to an exemplary embodiment of the present invention. As shown in FIG. 1, the TV 100 according to an exemplary embodiment of the present invention includes a broadcasting receiver 10, a signal processing unit 20, a display unit 30, a connection unit 40, an externally connected Hard Disc Drive (HDD) controller 41, a built-in HDD 50, a data storage module 60, a user selector 70, a User Interface (UI) generator 80 and a controller 90.

The broadcasting receiver 10 includes an antenna 11, a digital tuner 13 and an analog tuner 15. The signal processing unit 20 includes a Moving Picture Experts Group (MPEG) decoder 21, an National Television System Committee (NTSC) decoder 23, an MPEG encoder 27 and a scaler 25.

The digital tuner 13 and the analog tuner 15 tune a digital broadcasting signal and an analog broadcasting signal which are respectively received through the antenna 11 into a broadcasting signal of a frequency band (channel) that corresponds to a tuning control signal of the controller 90.

The digital broadcasting signal of the tuned particular channel is output in the form of a transport stream through a Vestigial Side Band (VSB) demodulation process and an error correction process in a demodulator (not shown). The digital broadcasting signal output in the form of the transport stream is separated into various kinds of additional data which are defined as a video signal, an audio signal and Program and Service Information Protocol information (PSIP) by a demultiplexer (not shown) and is output in the form of a bit-stream.

The video signal of the Moving Picture Experts Group (MPEG) signal type separated through the demultiplexer is decoded by the MPEG decoder 21. Moreover, the analog video signal according to the National Television System Committee (NTSC) signal type tuned by the analog tuner 15 is decoded by the NTSC decoder 23.

The analog video signal and the digital video signal which undergo the decoding are displayed on the display unit 30 through the scaler 25.

Here, the display unit 30 may be one of various types such as a Digital Light Processing (DLP), a Liquid Crystal Display (LCD), and a Plasma Display Panel (PDP). The scaler 25 converts a video signal so that when displayed it fits a vertical frequency, a resolution, an aspect ratio, or the like, of the display unit 30.

In the meantime, an audio signal is decoded by an audio decoder (not shown) and output to a speaker (not shown).

The MPEG encoder 27 encodes an analog broadcasting signal and converts the analog broadcasting signal into an MPEG signal type. The encoded digital data by the MPEG encoder 27 is output to an externally connected HDD 200 through the connection unit 40 by the externally connected HDD controller 41, or output to the built-in HDD 50. The analog broadcasting signal is transformed into a digital form through the MPEG encoder 27 and is stored in a storage medium such as the built-in HDD 50 or the externally connected HDD 200.

The connection unit 40 is connected with an external storage medium including the externally connected HDD 200 and a Video Cassette Recorder (VCR) 300. In order to store data in the externally connected HDD 200 or read data stored in the externally connected HDD 200, the externally connected HDD controller 41 interfaces with the externally connected HDD 200 via the connection unit 40. Moreover, the analog broadcasting signal can be stored in the external VCR 300 under the control of the controller 90.

In the meantime, the data storage module 60 according to the exemplary embodiment of the present invention includes a priority storage unit 61, a reservation information storage unit 63 and an Electronic Program Guide (EPG) storage unit 65.

The priority storage unit 61 stores storage priority information of storage media for the reserve-recording of broadcasting programs. The reservation information storage unit 63 stores channel information, and information on a start time and an end time of a broadcasting program of which is selected as a reserve-recording. The EPG storage unit 65 stores EPG information, which is guide information relating to broadcasting programs. The EPG information is included among the various kinds of additional data that is separated by the demultiplexer under the control of the controller 90.

The user selector 70 can include a menu key provided in a wireless remote control and a key signal generator generating a key signal in response to a key stroke so as to perform a channel selection of the TV 100, a selection of a priority of storage media and a selection of a reserve-recording function. Here, the user selector 70 may include any one of a mouse, a keyboard, or the like, or may be included in a main body panel of the digital television 100.

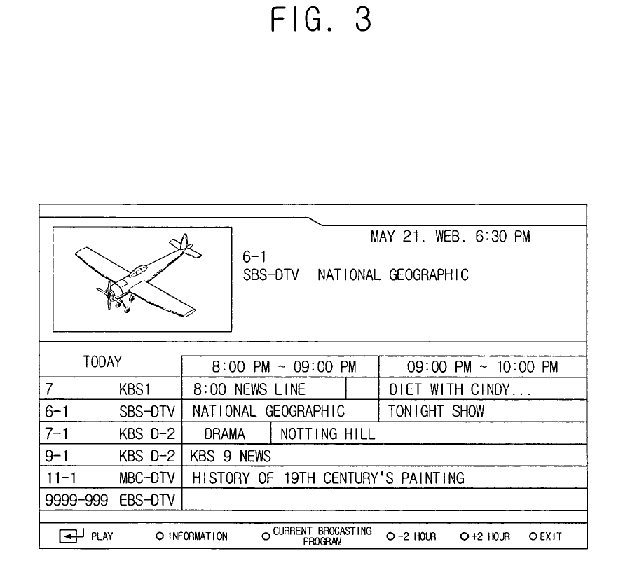

The UI generator 80 generates an EPG information table (refer to FIG. 3) for a UI selection menu that is used for the selection of a priority of the storage media and/or reserve-recording of broadcasting programs under the control of the controller 90.

The controller 90 receives a key signal from the user selector 70 and controls a corresponding function to be performed. The controller 90 is implemented by a microcomputer, a CPU and/or a processor.

The controller 90 controls the UI generator 80 to produce a priority setting menu, if a priority setting function of the storage media is selected through the user selector 70. The produced priority setting menu is synthesized in the scaler 25 together with a broadcasting signal which is currently being processed and displayed on the display unit 30. A user can set up a priority for a desired sequence of storage media through the user selector 70. The set up priority information is stored in the priority storage unit 61 under the control of the controller 90.

If an EPG information display function is selected through the user selector 70, the controller 90 reads the EPG information stored in EPG storage unit 65 and controls the UI generator 80 to produce an EPG table. In the case that a reserve-recording function of the broadcasting programs is selected on the EPG information table through the user selector 70, the reservation information of the selected broadcasting programs is stored in the reservation information storage unit 63.

In the meantime, according to the reservation information stored in the reservation information storage unit 63, the controller 90 controls a power source (not shown) to apply electrical power to the elements in the TV 100, including the broadcasting receiver 10 and the signal processing unit 20, that are necessary for the reserve-recording before the start time of the reserved program. The reserved program is the broadcasting program to be reserve-recorded. The controller 90 controls the reserved programs to be recorded in the storage media according to the start time and end time of the reserved programs and the priority set up in the priority storage unit 61.

Here, if it is determined that the storage medium according to a highest priority has insufficient storage capacity or is not connected to the connection unit 40, the controller 90 can control the reserved program to be recorded in a storage medium having the next highest priority. The more detailed description of the controller 90 will be described later.

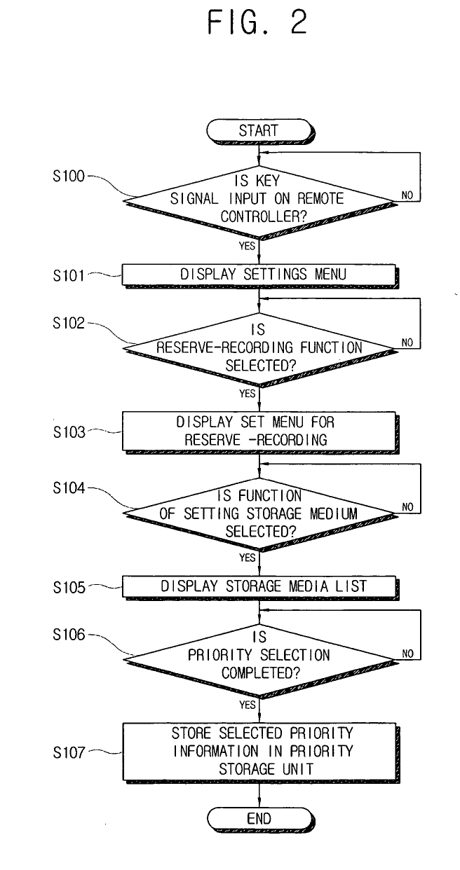

FIG. 2 is a flowchart for establishing a priority for storage media according to an exemplary embodiment of the present invention.

If a particular key on the remote control is manipulated (S100), and thus, if a corresponding key input signal is applied to the controller 90 in the TV 100, the controller 90 controls the UI generator 80 to produce a settings menu of the TV 100. The generated settings menu is synthesized with a broadcasting signal which is currently being processed in the scaler 25, and is displayed on the display unit 30 (S101).

If a user selects the reserve-recording function in the settings menu displayed on the display unit 30 (S102), the controller 90 controls the UI generator 80 to produce a menu for the reserve-recording function to be displayed on the display unit 30 according to a corresponding key input signal (S103).

Next, if a function of setting a storage medium is selected in the menu for reserve-recording through the user selector 70 (S104), the controller 90 controls the UI generator 80 to produce a list of the storage media to be displayed on the display unit 30 (S105). If selection of the priority of the storage media on the list is completed through the user selector 70 (S106), the controller 90 controls the priority information selected through the user selector 70 to be stored in the priority storage unit 61 (S107). In this manner, a user can establish the priority so that the reserved program can be stored in a desired storage medium.

FIG. 3 shows an EPG information table illustrating a reserve-recording method of the TV 100 according to an exemplary embodiment of the present invention.

The TV 100 according to the exemplary embodiment of the present invention can select a reserve-recording function using EPG information. If a user selects an EPG display function through the user selector 70, information relating to broadcasting programs is indicated by hour and by channel in an EPG information table as shown in FIG. 3. A user may select the reserve-recording of a desired program using the EPG information table. If a desired program is selected through the user selector 70 and is subsequently selected as the reserve-recording program, the controller 90 controls the selected reservation program information to be stored in the reservation information storage unit 63.

Accordingly, with the reservation information and priority information, the reserved program of the corresponding channel is reserve-recorded in the corresponding storage medium.

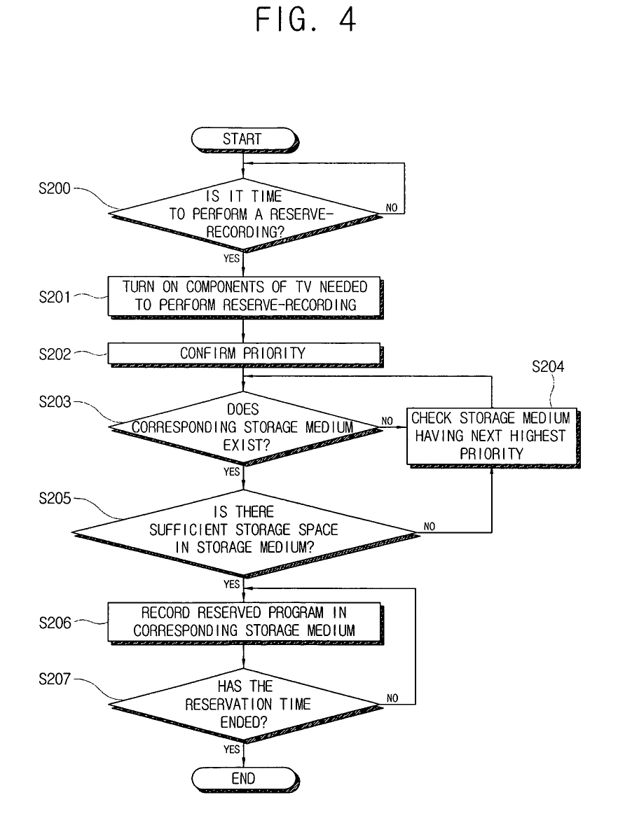

FIG. 4 is a flowchart view illustrating a control operation of the TV 100 performing a reserve-recording according to an exemplary embodiment of the present invention.

If it becomes time to perform a reserve-recording of a corresponding reserved program (S200), components of TV 100 needed to perform the reserve-recording are automatically turned on (S201). Here, the components of TV 100 needed to perform the reserve-recording can be set up to turn on several minutes before the start time of the reserved program. The controller 90 controls the storage media as well as the broadcasting receiver 10 and the signal processing unit 20 required to perform the reserve-recording.

The controller 90 confirms the priority information of the storage media stored in the priority storage unit 61 (S202), to thereby check the storage medium of the highest priority. More specifically, the controller 90 determines whether or not a corresponding storage medium exists (S203). For example, in the case that the priority of the storage media is set up in the sequence of the built-in HDD 50, the externally connected HDD 200, and the VCR 300, the controller 90 first determines whether or not the built-in HDD 50 exists (S203).

If the built-in HDD 50 does not exist in the first priority, the controller 90 checks the storage medium of the next priority (S204). That is, the controller 90 sequentially determines whether or not the externally connected HDD 200 and the VCR 300 which are the next priority in succession, are connected to the connection unit 40. Here, in case of the externally connected HDD 200, the controller 90 can communicate with the externally connected HDD 200 through an IEEE 1394 interface. Also, in case of the VCR 300, the controller 90 can communicate with the VCR 300 through Universal Asynchronous Receiver/Transmitter (UART) communications such as RS-232C.

If the storage medium having the highest priority exists or is connected to the TV 100, the controller 90 confirms whether or not the storage space is sufficient (S205). If the storage space is not sufficient, the controller 90 checks the storage space of the storage medium having the next highest priority (S204). In this manner, the controller 90 confirms whether or not the storage medium can perform the recording function according to the priority information which is stored in the priority storage unit 61. The storage medium having the next highest priority performs the recording function if the storage medium having the higher priority car not perform the recording function. Here, it can be confirmed whether or not the storage space in the storage medium is sufficient by estimating an amount of data for the reserved program from information on the playtime included in the EPG information.

If the storage space in the corresponding storage medium is sufficient (S205), the controller 90 controls the broadcasting receiver 10 to tune the corresponding reserved program and the signal processing unit 20 to process the tuned reserved program to then be recorded in the corresponding storage medium (S206). It is then determined if the reservation time haws ended (S207).

Meanwhile, the controller 90 receives broadcasting signals of the tuned channel and analyzes whether or not data output from the MPEG decoder 21 and the NTSC decoder 23 is effective, prior to be recorded on the storage medium. For digital broadcasting, the controller 90 analyzes the transport data stream output from the MPEG decoder 21 and then determines whether or not a video Packet Identifier (PID) and an audio PID match the reservation information. For analog broadcasting, the controller 90 checks whether or not the CVBS signal output from the NTSC decoder 23 has a normal synchronization signal (Sync). If the controller 90 determines that the received channel broadcasting signal is normal, the received channel broadcasting signal is recorded in the corresponding storage medium according to the storage priority.

For example, if the sequence of priority of the storage media is set up as the built-in HDD 50, the externally connected HDD 200, and the VCR 300 and the reserved program is a digital broadcast, the controller 90 controls the built-in HDD 50 to store the tuned reserved program. If the built-in HDD 50 does not have sufficient storage space, the controller 90 controls the externally connected HDD 200 to store the reserved program under the control of the externally connected HDD controller 41. If the reserved program is an analog broadcast, the controller 90 controls the MPEG encoder 27 to convert the tuned reserved program into a digital signal to be stored in the built-in HDD 50. If the built-in HDD 50 does not have sufficient storage space, the controller 90 controls the externally connected HDD 200 to store the reserved program under the control of the externally connected HDD controller 41.

Accordingly, the storage medium is selected according to the priority and it is checked whether or not the storage medium can store a reserved program. As a result, the reserved program can be automatically recorded according to the storage priority, to thereby provide users with convenience.

Exemplary embodiments of the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, functional programs, codes, and code segments for accomplishing the present invention can be easily construed as within the scope of the invention by programmers skilled in the art to which the present invention pertains.

As described in the above, according to exemplary embodiments of the present invention, provided are the display apparatus and the control method in which a priority of storage media for reserve-recording is set in advance, and broadcasting programs to be reserve-recorded are selected and automatically recorded on a respective corresponding storage media.

While certain exemplary embodiments of the invention has have been shown and described hereinwith reference to a certain preferred embodiments thereof, it will be understood by those skilled in the art that various changes in form and details may be made therein without departing from the spirit and scope of the invention as defined by the appended claims and their equivalents.

What is claimed is:

1. A display apparatus including a broadcasting receiver for receiving a broadcast signal, a signal processing unit for processing the received broadcast signal, a display unit for displaying the processed broadcast signal thereon, a connection unit to which at least one external storage medium is connected, and an internal storage medium, the display apparatus comprising:
a user selector;
a priority storage unit for storing a storage priority of the external storage medium and the internal storage medium for the reserve-recording of a broadcasting program;
a reservation information storage unit for storing reservation information related to the broadcasting program to be reserve-recorded; and
a controller for controlling the reservation information relating to a selected broadcasting program to be stored in the reservation information storage unit if the broadcasting program to be reserve-recorded is selected through the user selector, and for receiving the broadcasting program to be reserve-recorded from the broadcasting receiver based on the reservation information in order to reserve-record the received broadcasting program on one of the external storage medium and the internal storage medium according to the storage priority.

2. The display apparatus of claim 1, further comprising: an Electronic Program Guide (EPG) storage unit for storing guide information relating to broadcasting programs received through the broadcasting receiver; and a User Interface (UI) generator for generating a guide information table relating to the broadcasting programs,
wherein the controller controls the guide information relating to the broadcasting program to be reserve-recorded, to be stored in the reservation information storage unit, if a predetermined program is selected as the broadcasting program to be reserve-recorded from the guide information table via the user selector.

3. The display apparatus of claim 2, wherein the connection unit comprises access ports connected to at least one of a Video Cassette Recorder (VCR) and a Hard Disc Drive (HDD), and the internal storage medium comprises a HDD.

4. The display apparatus of claim 1, wherein the signal processing unit comprises an analog decoder for converting analog broadcasting signals into digital broadcasting signals, and a digital decoder for decoding the digital broadcasting signals.

5. The display apparatus of claim 1, wherein, and the controller comprises a Central Processing Unit (CPU), microcomputer, or processor.

6. The display apparatus of claim 2, wherein the UI generator produces a priority setting menu for setting the storage priority of the external storage medium and the internal storage medium for the reserve-recording of the broadcasting program, and wherein the controller controls the UI generator to produce the priority setting menu for display on the display unit, if a priority setting function is selected from the user selector, and the controller controls the priority storage unit to store information relating to a selected storage priority if the storage priority is selected through the user selector.

7. A control method of controlling a display apparatus including a broadcasting receiver for receiving a broadcast signal, a signal processing unit for processing the received broadcast signal, a display unit for displaying the processed broadcast signal thereon, a connection unit connected to at least one external storage medium, an internal storage medium and a user selector, the control method comprising the steps of:
storing a storage priority of the external storage medium and the internal storage medium for the reserve-recording of a broadcasting program selected via the user selector;
storing reservation information relating to a selected broadcasting program, if the broadcasting program to be reserve-recorded is selected via the user selector; and
receiving the broadcasting program to be reserve-recorded from the broadcasting receiver based on the reservation information, and reserve-recording the received broadcasting program on one of the external storage medium and the internal storage medium according to the storage priority.

8. The control method as claimed in claim 7, further comprising: storing broadcasting program guide information received through the broadcasting receiver; and generating and displaying a guide information table relating to broadcasting programs, if a guide information display function is selected via the user selector,
wherein the storing of the reservation information comprises storing the guide information relating to the reserved broadcasting program to be reserve-recorded, if a program is selected as the broadcasting program to be reserve-recorded from the guide information table via the user selector.

9. The control method as claimed in claim 8, wherein the connection unit comprises access ports connected to at least one of a Video Cassette Recorder (VCR) and a Hard Disc Drive (HDD), and the internal storage medium comprises an HDD.

10. The control method as claimed in claim 8, further comprising: displaying a priority setting menu on the display unit, if a priority setting function is selected from the user selector.

11. A display apparatus including a broadcasting receiver for receiving a broadcast signal, a signal processing unit for processing the received broadcast signal, a display unit for displaying the processed broadcast signal, a connection unit connected to at least one external storage medium, and an internal storage medium, the display apparatus comprising:
a user selector;
a priority storage unit for storing a storage priority of the external storage medium and the internal storage medium for the reserve-recording of a broadcasting program;
a User Interface (UI) generator for producing a UI menu for setting the storage priority;
a controller for controlling the UI generator to produce the UI menu to be displayed on the display unit if the storage priority is selected through the user selector, and for controlling the priority storage unit to store information relating to the storage priority selected via the user selector.

12. The display apparatus as claimed in claim 11, further comprising a reservation information storage unit for storing reservation information relating to the broadcasting program to be reserve-recorded, wherein the controller controls the reservation information storage unit to store the reservation information relating to a selected broadcasting program if the broadcasting program to be reserve-recorded is selected via the user selector, and the controller receives the reserved broadcasting program to be reserve-recorded based on the reservation information in order to reserve-recorded on one of the external storage medium and the internal storage medium according to the storage priority.

13. The display apparatus of claim 12, further comprising: an Electronic Program Guide (EPG) storage unit for storing guide information relating to broadcasting programs received through the broadcasting receiver; and the User Interface (UI) generator for generating a guide information table relating to the broadcasting programs,
wherein the controller controls the guide information relating to the broadcasting program to be reserve-recorded to be stored in the reservation information storage unit, if a broadcasting program is selected to be reserve-recorded from the guide information via the user selector.

14. The display apparatus of claim 13, wherein the connection unit comprises access ports connected to at least one of a Video Cassette Recorder (VCR) and a Hard Disc Drive (HDD), and the internal storage medium is a HDD.

15. A computer-readable medium having embodied thereon a computer program for the method of controlling a display apparatus including a broadcasting receiver for receiving a broadcast signal, a signal processing unit for processing the received broadcast signal, a display unit for displaying the processed broadcast signal thereon, a connection unit connected to at least one external storage medium, an internal storage medium and a user selector, the method comprising:
storing a storage priority of the external storage medium and the internal storage medium for the reserve-recording of a broadcasting program selected via the user selector;
storing reservation information relating to a selected broadcasting program, if the broadcasting program to be reserve-recorded is selected via the user selector; and receiving the broadcasting program to be reserve-recorded from the broadcasting receiver based on the reservation information, and reserve-recording the received broadcasting program on one of the external storage medium and the internal storage medium according to the storage priority.
